(19) United States
(12) Patent Application Publication
(10) Pub. No.: US 2026/0228508 A1
(43) Pub. Date: Aug. 6, 2026

(54) FINE-TUNING A LIKELIHOOD-BASED GENERATIVE MODEL BY CONTRASTING TO TRAINING DATA

(71) Applicant: NVIDIA Corporation, Santa Clara, CA (US)

(72) Inventors: Qinsheng Zhang, Atlanta, GA (US); Kaiwen Zheng, Santa Clara, CA (US); Yongxin Chen, Suwanee, GA (US); Ming-Yu Liu, Redwood City, CA (US)

(21) Appl. No.: 19/366,355

(22) Filed: Oct. 22, 2025

Related U.S. Application Data
(60) Provisional application No. 63/753,226, filed on Feb. 3, 2025.

(51) Int. Cl. G06N 3/0475; G06T 11/00; G06V 10/82

(52) U.S. Cl. CPC G06N 3/0475; G06T 11/00; G06V 10/82

(57) ABSTRACT

Diffusion and autoregressive models are representatives of likelihood-based generative models which aim to learn an underlying data distribution by maximizing the likelihood of the observed data under a parameterized probabilistic model. These likelihood-based generative models are particularly effective at performing visual tasks such as image and video synthesis. However, the maximum likelihood estimation (MILE) objective entails inherent limitations, such as forcing the learned density to spread out excessively, potentially leading to blurry samples. The present disclosure improves likelihood-based generative models by contrasting to training data, which can push the performance of likelihood-based generative models beyond the limits of MLE.

### CLAIM OF PRIORITY

This application claims the benefit of U.S. Provisional Application No. 63/753,226 (Attorney Docket No. NVIDP1435+/25-SC-0136US01) titled “DIRECT DISCRIMINATIVE OPTIMIZATION: IMPROVING LIKELIHOOD-BASED VISUAL GENERATIVE MODELS BY CONTRASTING TO TRAINING DATA,” filed Feb. 3, 2025, the entire contents of which is incorporated herein by reference.

### TECHNICAL FIELD

The present disclosure relates to training likelihood-based generative models.

### BACKGROUND

Modeling the distribution of high-dimensional data is a fundamental challenge in machine learning. Recent years have witnessed the domination of diffusion and autoregressive paradigms in generative modeling of continuous data and discrete data. They have achieved both theoretical and empirical success in visual tasks including image and video synthesis, forming the cornerstone of large-scale generation systems in the era of artificial intelligence (AI)-generated content.

Diffusion and autoregressive models are representatives of likelihood-based generative models. Compared to Generative Adversarial Networks (GANs) which often face unstable training and mode collapse issues, these models are distinguished by their stability, scalability, and generalizability. Likelihood-based generative models aim to learn the underlying data distribution by maximizing the likelihood of the observed data under a parameterized probabilistic model, which is equivalent to minimizing the forward Kullback-Leibler (KL) divergence.

However, this maximum likelihood estimation (ILE) objective entails inherent limitations. Forward KL is known to prioritize “mode-covering” and imposes extreme penalties if the model severely underestimates the likelihood of any training sample. Under limited model capacity, this property forces the learned density to spread out excessively, potentially leading to blurry samples-a phenomenon commonly observed in Variational Autoencoders (VAEs) and in likelihood training of diffusion models. Consequently, these models often rely heavily on guidance methods to steer the samples away from unlikely low-probability regions and toward the core of the data manifold in order to improve overall generation quality. In contrast, GANs, which are theoretically grounded in Jensen-Shannon (JS) divergence or Wasserstein distance tend to produce sharper and more realistic samples.

There is thus a need for addressing these issues and/or other issues associated with the prior art. For example, there is a need to improve likelihood-based generative models by contrasting to training data, which can push the performance of likelihood-based generative models beyond the limits of MLE.

### SUMMARY

A method, computer readable medium, and system are disclosed for fine-tuning a likelihood-based generative model. A plurality of ground truth data samples and a plurality of reference data samples generated by a pretrained reference likelihood-based generative model are processed, by a generative adversarial network (GAN) discriminator model parameterized using a target likelihood-based generative model, to generate classifications for the plurality of reference data samples and the plurality of ground truth data samples. The target likelihood-based generative model is fine-tuned based on a loss computed from the classifications.

### BRIEF DESCRIPTION OF THE DRAWINGS

FIG. 1 illustrates a method for fine-tuning a likelihood-based generative model, in accordance with an embodiment.

FIG. 2 illustrates a method for generating classifications of data samples drawn from a training data set and data samples generated by a pretrained reference likelihood-based generative model, in accordance with an embodiment.

FIG. 3 illustrates a method for using data sample classifications to fine-tune a target likelihood-based generative model, in accordance with an embodiment.

FIG. 4 illustrates a system pipeline for fine-tuning a likelihood-based generative model, in accordance with an embodiment.

FIG. 5 illustrates a visual comparison of the direct discriminative optimization (DDO) method of the system pipeline of FIG. 4 with the prior art direct preference optimization (DPO) method, in accordance with an embodiment.

FIG. 6 illustrates a method of a likelihood-based generative model, in accordance with an embodiment.

FIG. 7A illustrates inference and/or training logic, according to at least one embodiment;

FIG. 7B illustrates inference and/or training logic, according to at least one embodiment;

FIG. 8 illustrates training and deployment of a neural network, according to at least one embodiment;

FIG. 9 illustrates an example data center system, according to at least one embodiment.

### DETAILED DESCRIPTION

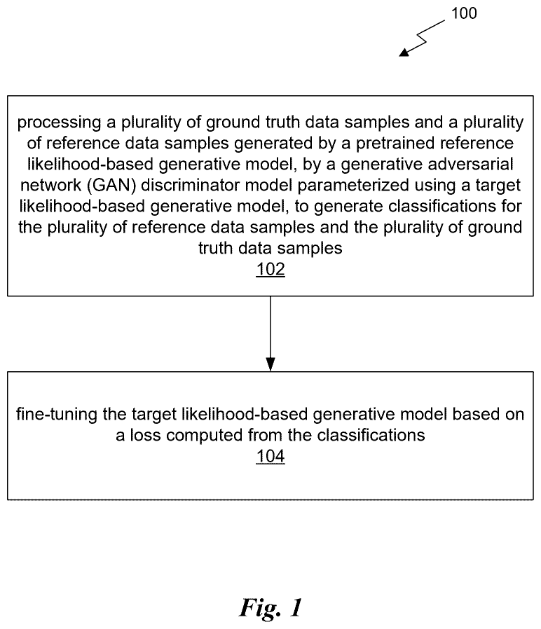

FIG. 1 illustrates a method 100 for fine-tuning a likelihood-based generative model, in accordance with an embodiment. The method 100 may be performed by a device, which may be comprised of a processing unit, a program, custom circuitry, or a combination thereof, in an embodiment. In another embodiment, a system comprised of a non-transitory memory storage comprising instructions, and one or more processors in communication with the memory, may execute the instructions to perform the method 100. In another embodiment, a non-transitory computer-readable media may store computer instructions which when executed by one or more processors of a device cause the device to perform the method 100.

Embodiments described herein refer to likelihood-based generative models. In the context of the present description, a likelihood-based generative model is a machine learning model that is configured to learn an underlying data distribution from training data and to use the learned distribution to generate new data samples. In embodiments, a likelihood-based generative model may be a diffusion model or an autoregressive model. In an embodiment, the likelihood-based generative models may be configured to perform a visual task, such as image or video synthesis.

The likelihood-based generative model that is fine-tuned in accordance with the method 100 is referred to herein as a target likelihood-based generative model. As described below, the target likelihood-based generative model is fine-tuned using a pretrained reference likelihood-based generative model. In an embodiment, the pretrained reference likelihood-based generative model is a likelihood-based generative model that has been pretrained on training data and that capable of being used as a reference for fine-tuning the target likelihood-based generative model.

In an embodiment, the target likelihood-based generative model may be initialized prior to the fine-tuning thereof per the method 100. In an embodiment, the target likelihood-based generative model may be initialized from the pretrained reference likelihood-based generative model. For example, the target likelihood-based generative model may be initialized as the pretrained reference likelihood-based generative model.

Returning to the method 100, in operation 102, a plurality of ground truth data samples and a plurality of reference data samples generated by the pretrained reference likelihood-based generative model are processed, by a generative adversarial network (GAN) discriminator model parameterized using the target likelihood-based generative model, to generate classifications for the plurality of reference data samples and the plurality of ground truth data samples. The ground truth data samples refer to data samples included in training data. The reference data samples refer to data samples generated by the pretrained reference likelihood-based generative model in either an offline process or an online process.

As mentioned, the ground truth data samples and the reference data samples are processed by a GAN discriminator model to generate a classification for the ground truth data samples and the reference data samples. The GAN discriminator model refers to a model that operates as a classifier to distinguish real data (i.e. the ground truth data samples) from the generated, or fake, data (i.e. the reference data samples). Thus, in an embodiment, each data sample is classified by the GAN discriminator model as being either one of the plurality of reference data samples or one of the ground truth data samples.

In the context of the present description, the GAN discriminator model is parameterized using the target likelihood-based generative model. In an embodiment, the GAN discriminator model includes both the target likelihood-based generative model and the reference likelihood-based generative model. In an embodiment, the GAN discriminator model is implicitly parameterized using a likelihood ratio between the target likelihood-based generative model and the pretrained reference likelihood-based generative model.

In operation 104, the target likelihood-based generative model is fine-tuned based on a loss computed from the classifications. The loss refers to a GAN loss. Fine-tuning the target likelihood-based generative model refers to updating existing parameters of the target likelihood-based generative model. In an embodiment, the fine-tuning may be performed to minimize the GAN loss computed from the classifications. In an embodiment, the pretrained reference likelihood-based generative model may be frozen during the fine-tuning. Thus, while the target likelihood-based generative model may be a learnable component of the GAN discriminator model, the pretrained reference likelihood-based generative model may remain fixed.

In an embodiment, by parameterizing the GAN discriminator model using the target likelihood-based generative model, for example by using the likelihood ratio between the target likelihood-based generative model and the pretrained reference likelihood-based generative model, the GAN loss can be leveraged to directly fine-tune the target likelihood-based generative model. In an embodiment, this parameterization may enable the direct fine-tuning without altering the network architecture or inference protocol. This implicit parameterization of the GAN discriminator model avoids the need for joint training of the generator and discriminator networks as well as avoids reliance on additional guidance terms that increase inference costs.

In an embodiment, the fine-tuning may be performed to optimize (e.g. improve., refine, etc.), the target likelihood-based generative model. In an embodiment, the fine-tuning may be performed to optimize a quality of data samples generated by the target likelihood-based generative model. The quality may be measured in terms of sharpness, realism, alignment to the training data, etc. In an embodiment, the fine-tuning may be performed over one or more iterations, to progressively fine-tune the target likelihood-based generative model.

In an embodiment, the method 100 may further include deploying the fine-tuned target likelihood-based generative model for performing one or more inferencing operations. In an embodiment, the fine-tuned target likelihood-based generative model may be a generative model that performs the one or more inferencing operations to generate new data. In an embodiment, the fine-tuned target likelihood-based generative model may be an autoregressive model that performs the one or more inferencing operations to predict a next data value in a sequence of data values.

### Exemplary Implementation of the Method 100

In an embodiment, the method 100 may be implemented to fine-tune a visual likelihood-based generative model. In this exemplary implementation, a target likelihood-based generative model is fine-tuned by: accessing a plurality of ground truth visual data samples (e.g. ground truth images) and a plurality of reference visual data samples (e.g. reference images) generated by a pretrained reference likelihood-based generative model, processing the plurality of ground truth visual data samples and the plurality of visual reference data samples by a GAN discriminator model parameterized using the target likelihood-based generative model, to generate classifications for the plurality of reference visual data samples and the plurality of ground truth visual data samples, computing a GAN loss from the classifications, and updating the target likelihood-based generative model to minimize the GAN loss. In this exemplary implementation, the fine-tuned target likelihood-based generative model may be deployed for: processing an input comprised of noise to generate a visual content (e.g. an image), and outputting the visual content (e.g. to a memory, a display, a downstream application, etc.).

Further embodiments will now be provided in the description of the subsequent figures. It should be noted that the embodiments disclosed herein with reference to the method 100 of FIG. 1 may apply to and/or be used in combination with any of the embodiments of the remaining figures below.

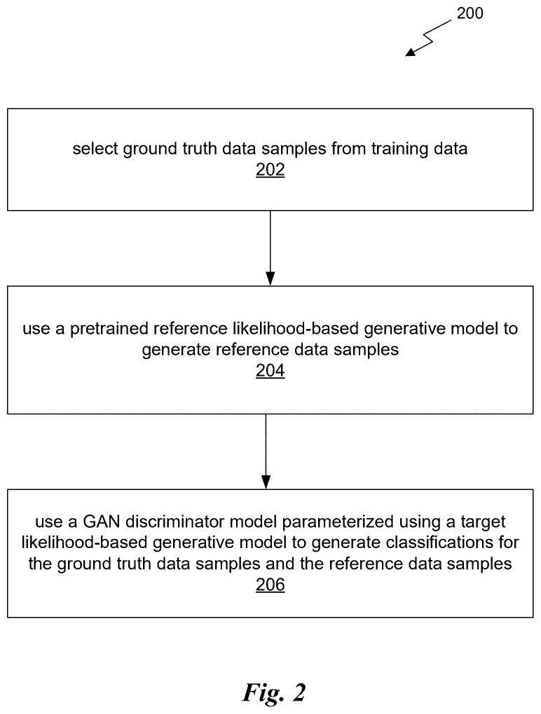

FIG. 2 illustrates a method 200 for generating classifications of data samples drawn from a training data set and data samples generated by a pretrained reference likelihood-based generative model, in accordance with an embodiment. The method 200 may be performed to carry out operation 102 of FIG. 1, in an embodiment. The definitions and descriptions provided above my equally apply to the present embodiment.

In operation 202, ground truth data samples are selected form training data. In an embodiment, the training data may be comprised of images. In an embodiment, each of the ground truth data samples may be a different image.

In operation 204, a pretrained reference likelihood-based generative model is used to generate reference data samples. In an embodiment, the reference likelihood-based generative model may be pretrained to generate data samples that are of the same type of the ground truth data samples. In an embodiment, the reference likelihood-based generative model may be pretrained to generate images. In an embodiment, the reference data samples may be different images generated by the pretrained reference likelihood-based generative model.

In operation 206, a GAN discriminator model parameterized using a target likelihood-based generative model is used to generate classifications for the ground truth data samples and the reference data samples. In an embodiment, the GAN discriminator model may classify the given data samples as either ground truth data samples or reference data samples.

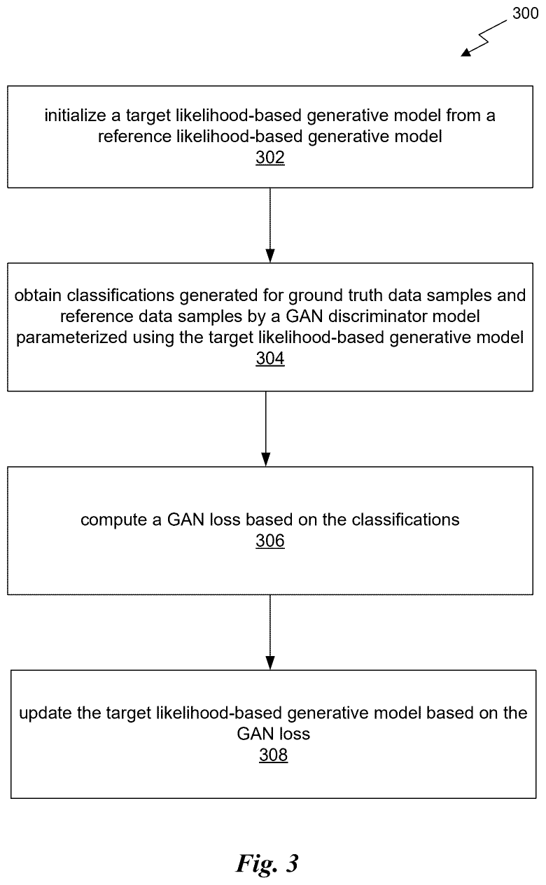

FIG. 3 illustrates a method 300 for using data sample classifications to fine-tune a target likelihood-based generative model, in accordance with an embodiment. The method 300 may be performed to carry out operation 104 of FIG. 1, in an embodiment. The definitions and descriptions provided above my equally apply to the present embodiment.

In operation 302, a target likelihood-based generative model is initialized from a reference likelihood-based generative model. In the present embodiment, the target likelihood-based generative model and the reference likelihood-based generative model are included in a GAN discriminator model. In the present embodiment, the GAN discriminator model is parameterized using the target likelihood-based generative model.

In operation 304, classifications generated for ground truth data samples and reference data samples by the GAN discriminator model are obtained (e.g. per the method 200 of FIG. 2). In operation 306, a GAN loss is computed based on the classifications. In operation 308, the target likelihood-based generative model is updated based on the GAN loss. In an embodiment, the target likelihood-based generative model may be updated to minimize the GAN loss.

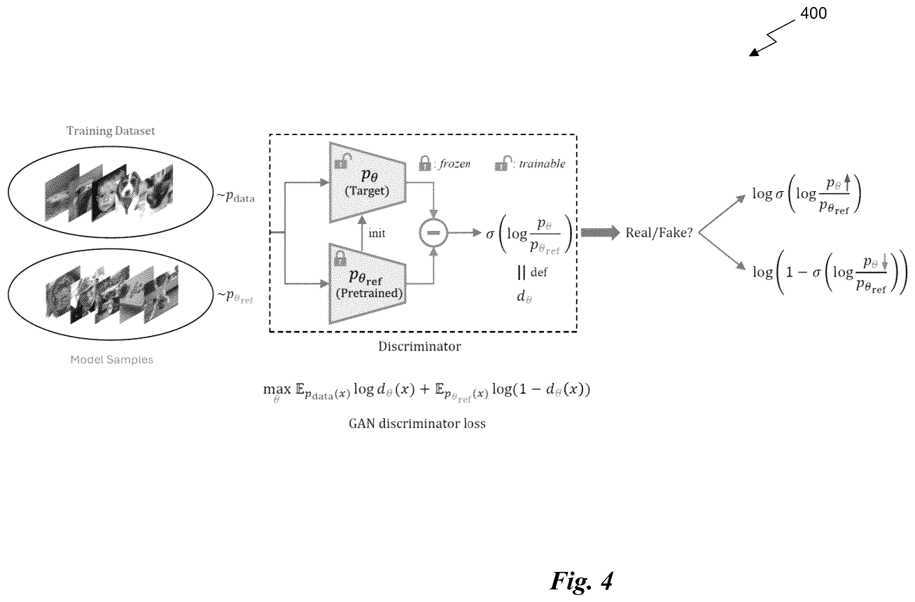

FIG. 4 illustrates a system pipeline 400 for fine-tuning a likelihood-based generative model, in accordance with an embodiment. The system pipeline 400 may be implemented to carry out the method 100 of FIG. 1, in an embodiment. Again, the definitions and descriptions provided above my equally apply to the present embodiment.

The system pipeline 400 is configured to leverage a GAN loss for fine-tuning a target likelihood-based generative model. Explanations of likelihood-based generative models and GANs are provided below, followed by a detailed description of the system pipeline 400.

### Likelihood-Based Generative Models

Likelihood-based generative models parameterize a probability distribution pe to learn the data distribution p_{data}, enabling explicit likelihood evaluation and density estimation. Among them, diffusion and autoregressive models are two prominent types that excel in visual generation. Autoregressive (AR) models learn discrete data distributions via the next-token prediction mechanism, per Equation 1.

$$log {p}_{θ} ( x ) = {\sum }_{n = 1}^{d} log {p}_{θ} ( {x}^{( n )} \vert {x}^{( < n )} ) \qquad Equation 1$$

where d denotes the data dimension (sequence length). It factorizes the joint distribution into a product of conditional probabilities, allowing exact likelihood computation. Each p_{θ}(⋅|x^{(<n)}) is parameterized via a Softmax operation over the model's output logits and optimized using cross-entropy loss against the ground-truth token. In visual autoregressive modeling, images are first quantized to discrete tokens within a compact latent space using autoencoders.

Diffusion models learn continuous data distributions by gradually perturbing clean data x₀~p_{data} with Gaussian noise, which generates a trajectory

$${\{ {x}_{t} \}}_{t = 0}^{T} ,$$

and then learning to reverse this process. The forward and backward dynamics can be formulated as either stochastic or ordinary differential equations (SDEs or ODEs). The forward process follows a closed-form transition kernel

$${q}_{t \vert 0} ( {x}_{t} \vert {x}_{0} ) = N ( {α}_{t} {x}_{0} , {σ}_{t}^{2} I )$$

with predefined noise schedule αₜ, σₜ, enabling reparameterization as xₜ=αₜx₀+σₜϵ, ϵ~N(0, I). The model is typically parameterized as a noise prediction network ϵ_{θ}(xₜ, t) trained to estimate c via mean squared error (MSE) regression, which forms an evidence (or variational) lower bound (ELBO) on the likelihood, per Equation 2.

$$log {p}_{θ} ( {x}_{0} ) \leq C - {𝔼}_{t ∼ p ( t ) , ϵ ∼ N ( 0 , I )} [ w ( t ) {‖ {ϵ}_{θ} ( {x}_{t} , t ) - ϵ ‖}_{2}^{2} ] \qquad Equation 2$$

where xₜ=αₜx+σₜϵ, C is a constant irrelevant to θ, and p(t), w(t) are certain time distribution and weighting function. The ELBO provides a reasonable likelihood approximation compared to the exact but cumbersome instantaneous change-of-variable formula in neural ODEs. Moreover, while the likelihood bound is tight only for specific p(t), w(t), alternative choices share the same optimum and can serve as surrogate objectives.

From the perspective of score matching, the optimal noise predictor is linked to the score function s*(xₜ, t):=∇xₜ log qₜ(xₜ) by ϵ*(xₜ)=−σₜs*(xₜ, t), where qₜ denotes the marginal distribution at time t in the forward process. Due to the properties of MSE, the network can be parameterized in alternative yet theoretically equivalent forms, such as a velocity predictor that estimates the tangent of the diffusion trajectory, commonly known as flow matching.

### GANs

GANs do not explicitly model the likelihood p_{θ} but instead directly optimize the data generation process through adversarial training. Specifically, the optimization involves an adversarial interplay between a generator network g_{θ}: [symbol] [symbol] [symbol] that maps latent variables z∈ [symbol] ~p(z)(typically Gaussian noise) into synthetic samples, and a discriminator network d_{Ø}: [symbol] [symbol] [0,1] that classifies samples as real or fake per Equation 3.

$${min}_{θ} {max}_{∅} {𝔼}_{{p}_{data} ( x )} [ log {d}_{∅} ( x ) ] + {𝔼}_{{p}_{θ} ( x )} [ log ( 1 - {d}_{∅} ( x ) ) ] \qquad Equation 3$$

Here p_{θ}(x) is the generator distribution, whose exact density is intractable but can be easily sampled from via x=g_{θ}(z), z~p(z). In the inner loop, the discriminator is optimized using binary cross-entropy loss (also known as noise contrastive estimation (NCE)), and its optimal solution can be derived per Equation 4.

$${d}^{*} ( x ) = \frac{{p}_{data} ( x )}{{p}_{data} ( x ) + {p}_{θ} ( x )} \qquad Equation 4$$

under which the minimax game becomes that shown in Equation 5.

$${min}_{θ} 2 {D}_{JS} ( {p}_{data} \vert \vert {p}_{θ} ) = 2 log 2 \qquad Equation 5$$

is the Jensen-Shannon (JS) divergence. This theoretically ensures that the optimal generator distribution matches the data distribution. However, in practice, training instability arises due to gradient vanishing and mode collapse, inspiring variants such as Wasserstein GANs. GANs can be incorporated to enhance other generative models. For example, Discriminator Guidance utilizes the gradient information from the discriminator as a corrective term to refine the score function in diffusion models. Additionally, GANs are commonly employed as an auxiliary loss to improve one-step generation such as in diffusion distillation.

### System Pipeline 400

Motivated by the benefits of adversarial training in enhancing generation quality, the embodiments described herein bridge likelihood-based generative models with GANs to derive an alternative training paradigm to MLE. Unlike prior works that incorporate GAN as an auxiliary loss and require additional engineering overhead, the embodiments described herein (1) directly optimize likelihood-based generative models without modifying the network architecture, adding extra discriminators, complicating the training procedure or increasing inference costs, and (2) eliminate the need for backpropagation through the sampling process, making it applicable to diffusion and autoregressive models that rely on iterative sampling.

### Likelihood-Based Generative Model as a Discriminator

Unlike one-step generators that learn a direct mapping from noise to data, likelihood-based generative models are grounded in the probabilistic definition of the likelihood function p_{θ}, which enables both the generation of samples x~p_{θ} and the evaluation of the likelihood p_{θ}(x), either exactly or approximately, while retaining the tractability of backpropagation through the likelihood computation. Accordingly, the likelihood information embedded in the optimal discriminator (Equation 4) can be used.

Specifically, consider a pretrained model p_{θ}_{_{ref}} as a reference to generate fake samples. The optimal discriminator d_{θ}, per Equation 6, can be rewritten as Equation 7.

$${min}_{θ} {𝔼}_{{p}_{data} ( x )} [ log {d}_{θ} ( x ) ] + {𝔼}_{{p}_{{θ}_{ref}} ( x )} [ log ( 1 - {d}_{θ} ( x ) ) ] \qquad Equation 6$$

$${d}^{*} ( x ) = \frac{{p}_{data} ( x )}{{p}_{data} ( x ) + {p}_{{θ}_{ref}} ( x )} = σ ( log \frac{{p}_{data} ( x )}{{p}_{{θ}_{ref}} ( x )} ) \qquad Equation 7$$

is the Sigmoid function. The data distribution p_{data} is available from d*. Therefore, parameterizing the discriminator d_{θ} using a likelihood-based target generative model p_{θ} per Equation 8:

$${d}_{θ} ( x ) := σ ( log \frac{{p}_{θ} ( x )}{{p}_{{θ}_{ref}} ( x )} ) \qquad Equation 8$$

then the optimal target model that minimizes the GAN discriminator loss matches the data distribution. This induced objective is formalized in the following theorem.

Theorem 1 (Optimality). With unlimited model capacity, the optimal likelihood-based model p_{θ} under the objective of Equation 10:

$${min}_{θ} ℒ ( θ ) = - {𝔼}_{{p}_{data} ( x )} [ log σ ( log \frac{{p}_{θ} ( x )}{{p}_{{θ}_{ref}} ( x )} ) ] - {𝔼}_{{p}_{{θ}_{ref}} ( x )} [ log ( 1 - σ ( log \frac{{p}_{θ} ( x )}{{p}_{{θ}_{ref}} ( x )} ) ) ] \qquad Equation 9$$

satisfies p_{θ*}=p_{data*}.

In contrast to previous GAN-based methods that introduce a separate discriminator network d_{Ø}, the above described approach implicitly defines the discriminator through a target generative model p_{θ}. While it is theoretically feasible to initialize θ, θ_{ref} arbitrarily and train from scratch, strong initial conditions facilitate optimization. In an embodiment, θ, θ_{ref} is initialized from widely available pretrained models, promoting steady improvement. The approach, as described herein, is referred to as Direct Discriminative Optimization (DDO), drawing parallels with Direct Preference Optimization (DPO), which aligns language models with human preferences by expressing the reward model in terms of the likelihood ratio between two policies.

As illustrated in FIG. 4, θ_{ref} is the (pretrained) reference model frozen during training. θ is the learnable model initialized as θ_{ref}. Samples from p_{data} are drawn from the training dataset. Samples from p_{θ}_{_{ref}} are generated by the reference model, either offline or online. The target model θ is optimized by applying the GAN discriminator loss with the implicitly parameterized discriminator d_{θ} to distinguish between real samples from p_{data} and fake samples from p_{θ}_{_{ref}}.

For a mechanistic understanding of DDO, the gradient of the loss function can be analyzed with respect to parameters θ, per Equation 10.

$${∇}_{θ} ℒ ( θ ) = \int {\underbrace{1 - {d}_{ϕ} ( x ) )}}_{∈ [ 0 , 1 ]} {{\underbrace{( {p}_{θ} ) ( x ) - {p}_{data} ( x ) )}}_{{p}_{θ} ( x ) ↑ when < 0}}_{{p}_{θ} ( x ) ↓ when > 0} {∇}_{θ} log {p}_{θ} ( x ) dx \qquad Equation 10$$

Intuitively, gradient descent increases the model likelihood p_{θ}(x) for data points x that satisfy p_{θ}(x)<p_{data}(x), and decreases it otherwise, pushing p_{θ} closer to p_{data}. Furthermore, the gradient magnitude is weighted by both the distance |p_{θ}(x)−p_{data}(x)| and 1−d_{θ}(x), assigning higher weights to samples discriminated as fake.

### Theoretical Analysis

Apart from the optimality guarantee, the behavior of the DDO objective is also analyzed when θ is not optimal. Specifically, the following question is investigated:

Is p_{θ} closer to p_{data} with a lower [symbol] (θ)?

Under certain assumptions, bounds can be established on the divergence between p_{θ} and p_{data} in terms of the difference between [symbol] (θ) to the optimal loss value [symbol] , as formalized in the following theorem.

Theorem 2 (Divergence Bounds). If

$$log \frac{{p}_{{θ}_{ref}}}{{p}_{data}} and log \frac{{p}_{θ}}{{p}_{{θ}_{ref}}}$$

are bounded, there exist some constants C₁,C₂ such that Equations 11 and 12 are true.

$${D}_{KL} ( {p}_{data} \vert \vert {p}_{θ} ) \leq {C}_{1} \sqrt{ℒ - {ℒ}^{*}} \qquad Equation 11$$

$${D}_{KL} ( {p}_{θ} \vert \vert {p}_{data} ) \leq {C}_{2} \sqrt{ℒ - {ℒ}^{*}} \qquad Equation 12$$

The assumption of bounded

$$log \frac{{p}_{θ}}{{p}_{{θ}_{ref}}}$$

implies that the optimized distribution does not deviate significantly from the reference distribution, which is reasonable when finetuning for a short duration. The assumption of bounded

$$log \frac{{{p}_{θ}}_{ref}}{{p}_{d a t a}}$$

imposes a constraint to the reference model regarding its mutual density coverage with the data distribution.

$$log \frac{{{p}_{θ}}_{ref}}{{p}_{d a t a}}$$

can be expected to be lower bounded, i.e., p_{θ}_{_{ref}} sufficiently covers p_{data}, which aligns with the characteristics of MLE-trained models. Under this condition, the forward KL D_{KL}(p_{data}∥p_{θ}) remains bounded by [symbol] However, bounding the reverse KL D_{KL}(p_{θ}∥p_{data}) requires an upper bound on

$$\frac{{p}_{{θ}_{ref}}}{{p}_{d a t a}} ,$$

which imposes a stronger constraint on p_{θ}_{_{ref}}.

### Implementations

There are several practical techniques that make DDO applicable to high-dimensional real-world data and diffusion models whose likelihood computation is expensive.

1. Generalized Objective with Extra Coefficients

The log-likelihood log p_{θ}(x) of likelihood-based generative models often scales with the data dimension and can reach magnitudes of 10³. As the DDO objective in Equation 9 involves a Sigmoid operation on log p_{θ}(x), this can lead to gradient vanishing and numerical precision issues. To address this, hyperparameters α, β may be added to control the relative weights of loss terms and scale the probability ratio, per Equation 13.

$${ℒ}_{α , β} ( θ ) = - {𝔼}_{{p}_{d a t a} ( x )} [ log σ ( β log \frac{{p}_{θ} ( x )}{{p}_{{θ}_{ref}} ( x )} ) ] - α {E}_{{p}_{{θ}_{ref}} ( x )} [ log ( 1 - σ ( β log \frac{{p}_{θ} ( x )}{{p}_{{θ}_{ref}} ( x )} ) ) ] \qquad Equation 13$$

The modified loss retains the same optimization trend, namely, increasing p_{θ}(x) for x~p_{data} and decreasing p_{θ}(x) for x~p_{θ}_{_{ref}}, but the optimum may “overshoot” the data distribution for β<1. Specifically:

Theorem 3. With unlimited model capacity, the optimal likelihood-based generative model θ that minimizes [symbol] (θ) satisfies

$${p}_{θ} * ∝ {p}_{{θ}_{ref}}^{1 - 1 / β} {p}_{data}^{1 / β}$$

for certain α.

This establishes a deep connection with guidance methods. In an embodiment, α and β across a wide range of values yield reasonable performance, and they may be swept over for the best results.

### 2. Handling Compute-Intensive Likelihood

Evaluating the model likelihood for a specific data point can be computationally intensive. In particular, unlike autoregressive models, which only require a single forward pass through the network to compute log p_{θ}(x) (Equation 1) due to the causal structure imposed by attention masks, diffusion models necessitate multiple forward passes over different timesteps to approximate log p_{θ}(x) through the ELBO (Equation 2). Specifically, the log-likelihood ratio in the DDO loss is defined per Equation 15.

$$log \frac{{p}_{θ} ( x )}{{p}_{{θ}_{ref}} ( x )} \approx - {𝔼}_{t , ϵ} [ Δ ( {x}_{t} , t , ϵ ) ] \qquad Equation 14$$

where xₜ=αₜx+σₜϵ and with Equation 15.

$$Δ ( {x}_{t} , t , ϵ ) = w ( t ) ( {‖ {ϵ}_{θ} ( {x}_{t} , t ) - ϵ ‖}_{2}^{2} - {‖ {ϵ}_{{θ}_{ref}} ( {x}_{t} , t ) - ϵ ‖}_{2}^{2} ) \qquad Equation 15$$

Jensen's inequality is applied pointwise to derive an upper bound for the loss using the convexity of the function −a log σ(x)−b log(1−σ(x)) for any a, b≥0, per Equation 16.

$$Equation 16$$

$$ℒ ( θ ) \approx - {E}_{{p}_{d a t a} ( x )} log σ ( {𝔼}_{t , ϵ} [ Δ ] ) - \text{} {𝔼}_{{p}_{{θ}_{r e f}} ( x )} log ( 1 - σ ( {𝔼}_{t , ϵ} [ Δ ] ) ) \leq - \text{} {E}_{t , ϵ} [ \text{} {𝔼}_{{p}_{d a t a} ( x )} log σ ( Δ ) + \text{} {E}_{{p}_{{θ}_{ref}} ( x )} log ( 1 - σ ( Δ ) ) ]$$

This treatment, analogous to the one used in Diffusion-DPO, enables the approximation of the diffusion DDO loss using a single forward pass for each x.

### 3. Multi-Round Refinement Via Self-Play

Due to the practical modifications for applicability, the optimization process of DDO provides useful gradient information in the early stage but does not converge to the data distribution in the final. To maximize the fine-tuning performance, a multi-round refinement strategy may be used, where the reference model p_{θ}_{_{ref}} is iteratively updated by replacing it with an improved version from the previous round:

$$Round n : … \to {\underbrace{{p}_{{θ}_{n - 1}^{*}}}}_{Reference} \to σ {\underbrace{( β log \frac{{p}_{{θ}_{n}}}{{p}_{{θ}_{n - 1}^{*}}} )}}_{Discriminator}$$

$$Round n + 1 : … \to {\underbrace{{p}_{{θ}_{n}^{*}}}}_{Reference} \to …$$

$$where {p}_{{θ}_{n}^{*}}$$

represents the best-performing model across different hyperparameter configurations an training iterations in round n. In each round, the reference model acts as a fixed generator, making the multi-round optimization analogous to the generator-discriminator interplay in GANs. However, unlike GANs, where both networks are explicitly optimized, the reference (generator) model is never updated directly. Instead, the generator is obtained from the discriminator in the previous round, leading to a form of self-play.

### Connection to Reinforcement Learning (RL)

At a high level, DDO enables visual generative models to utilize negative signals from self-generated samples—a characteristic deeply rooted in RL that underpins modem language models. Distinguished from works that employ a similar contrastive loss merely to off-the-shelf data, DDO can fundamentally improve the base model's ability.

Extension to f-Divergence

The GAN discriminator loss can be generalized to f-divergences, per Equation 17.

$${D}_{f} ( p ‖ q ) = \begin{matrix}sup \\ T\end{matrix} [ T ( x ) ] - {𝔼}_{p ( x )} [ T ( x ) ] - {𝔼}_{q ( x )} [ {f}^{*} ( T ( x ) ) ] \qquad Equation 17$$

$${D}_{f} ( p ‖ q ) = {sup}_{T} = {𝔼}_{p ( x )} [ T ( x ) ] - {𝔼}_{q ( x )} [ {f}^{*} ( T ( x ) ) ] \qquad ( 17 )$$

$$where {f}^{*} is the covex conjugate of f . DDO can be extended to this family as the optimal {T}^{⋆} ( x ) = {f}^{′} ( \frac{p ( x )}{q ( x )} ) explicitly involves the density ratio .$$

where f* is the convex conjugate of f. DDO can be extended to this family as the optimal

$${T}^{*} ( x ) = {f}^{′} ( \frac{p ( x )}{q ( x )} )$$

explicitly involves the density ratio.
Comparison of DDO with DPO

DPO is an existing lightweight surrogate objective designed for reinforcement learning from human feedback (RLHF) that enhances the instruction-following ability of pretrained language models. Standard RLHF involves two stages: (1) learning a reward model r_{θ} and (2) aligning the reference policy π_{θ}_{_{ref}} to the target policy π_{θ}(y|x)∝π_{θ}_{_{ref}}(y|x)e^{r}^{_{θ}}^{(x,y)/β} using RL, where x is the prompt and y is the response. The Bradley-Terry preference mode links preferences and rewards using Equation 18.

$$p ( {y}_{w} ≻ {y}_{l} \vert x ) : = \frac{{e}^{r ( x , {y}_{w} )}}{{e}^{r ( x , {y}_{l} ) + {e}^{r ( x , {y}_{w} )}}} = σ ( r ( x , {y}_{w} ) = r ( x , {y}_{l} ) ) \qquad Equation 18$$

where y_{w} and yₗ denote the winning and losing responses for a given prompt x, annotated by human. DPO enables direct optimization of pretrained language models on preference data without training a separate reward model, per Equation 19.

$${ℒ}^{D P O} ( θ ) = - {𝔼}_{x , {y}_{w} , {y}_{l} ) ∼ D} log σ ( β log \frac{{π}_{θ} ( {y}_{w} \vert x )}{{π}_{{θ}_{ref}} ( {y}_{w} \vert x )} - β log \frac{{π}_{θ} ( {y}_{l} \vert x )}{{π}_{{θ}_{ref}} ( {y}_{l} \vert x )} ) \qquad Equation 19$$

where the reward function r_{θ}(y, x) is implicitly parameterized by the log-likelihood ratio

$$β log \frac{{π}_{θ} ( y \vert x )}{{π}_{{θ}_{ref}} ( y \vert x )} .$$

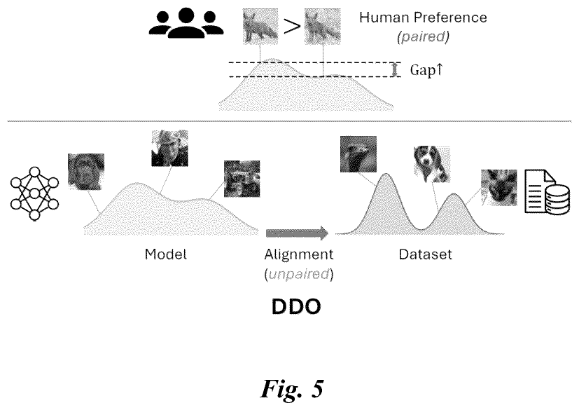

Despite sharing similar insights in parameterization, DDO is fundamentally different from DPO. As illustrated in FIG. 5, DPO is designed for preference learning, requiring additional paired human-annotated data and maximizing the likelihood gap between preferred (winning) and nonpreferred (losing) responses without considering the whole distribution. In contrast, DDO focuses on distribution alignment, directly aligning the model with the ground-truth data distribution. It requires only the original training data that are unpaired with the model-generated samples.

Comparison of DPO with Guidance Methods

There are several existing types of guidance methods that enhance diffusion models at inference time, such as classifier-free guidance (CFG), discriminator guidance, and autoguidance. Unlike guidance methods, however, DDO enhances sample quality without increasing inference costs compared to the base model. Moreover, in scenarios where CFG is crucial for balancing image-condition alignment and diversity, DDO can be seamlessly integrated with CFG to achieve an overall improved trade-off.

### SUMMARY

Embodiments described above introduce DDO, a universal enhancement technique designed for likelihood-based generative models, including visual. Inspired by the GAN framework and the parameterization insights from DPO, DDO breaks the curse of forward KL and substantially improves generation quality. DDO demonstrates remarkable effectiveness and efficiency, surpassing state-of-the-art diffusion and autoregressive models and achieving record-breaking Frechet inception distance (FID) scores on standard image benchmarks.

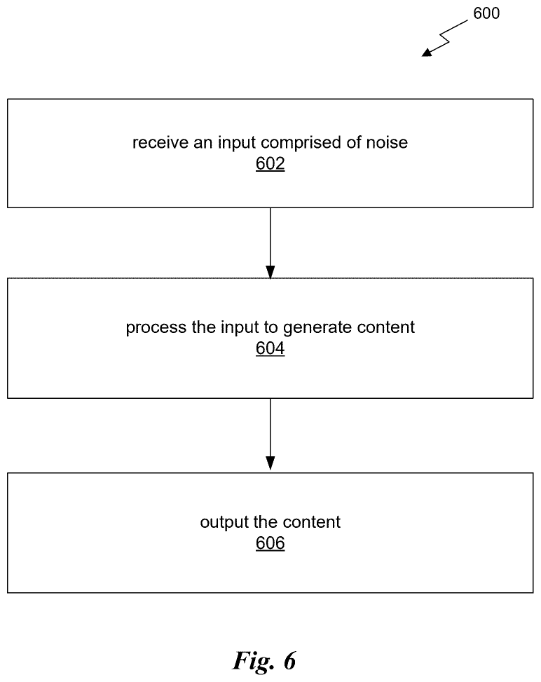

FIG. 6 illustrates a method 600 of a likelihood-based generative model, in accordance with an embodiment. The method 600 may be performed by a likelihood-based generative model that has been fine-tuned in accordance with the method 100 of FIG. 1 and/or any of the additional embodiments described above.

In operation 602, an input comprised of noise is received. In an embodiment, the input may be received from a user. In an embodiment, the input may be received from an application or process.

In an embodiment, the input is a random noise vector. In an embodiment, the input may be sampled from a simple prior distribution, such as a Gaussian distribution. In an embodiment, the input may also include a condition. In an embodiment, the condition may be a sample image or a low-resolution image. In an embodiment, the condition may be a text prompt. In an embodiment, the condition may be a combination of an image and a text prompt.

In operation 604, the input is processed to generate content. In particular, the likelihood-based generative model processes the input to generate one or more new samples. In an embodiment, the likelihood-based generative model generates the content by sampling from its learned distribution. In an embodiment, the content may be an image, a video, a written work, etc.

In an embodiment, the content generated by the likelihood-based generative model is an image. For example, given an input image of a first resolution, the likelihood-based generative model may generate the image with a second resolution that is higher than the first resolution. As another example, given an input text prompt, which may be an instruction or a few starting words, the likelihood-based generative model may generate a coherent sequence of text (e.g. as a written work).

In operation 606, the content is output. In an embodiment, the content may be output to a memory. In an embodiment, the content may be output to a display. In an embodiment, the content may be output to a downstream application, such as an augmented/virtual reality (AR/VR) application that uses the content to generate AR/VR content.

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where a trained neural network is applied to new inputs it has not seen before to classify images, translate speech, and generally infer new information.

### Inference and Training Logic

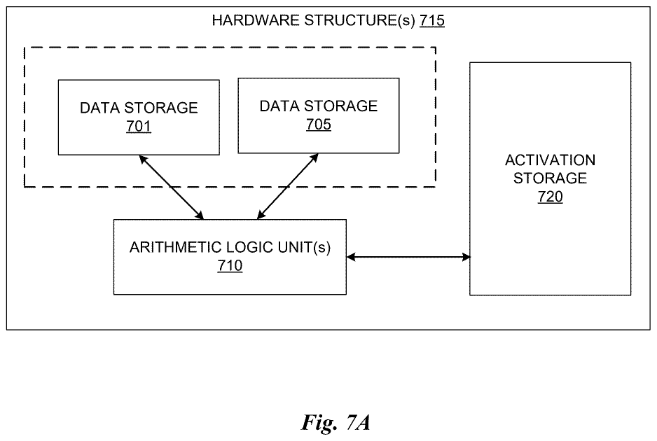

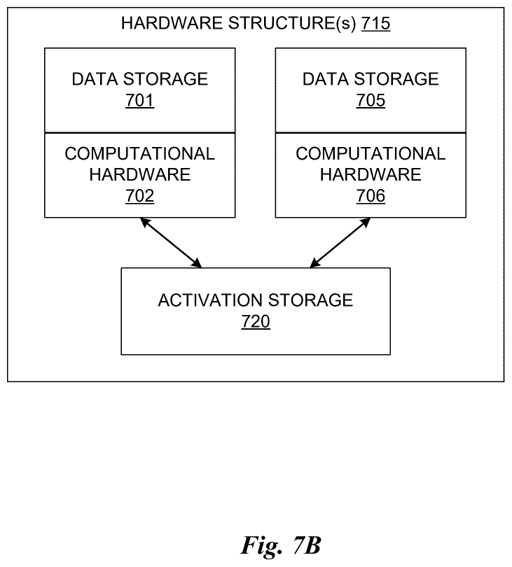

As noted above, a deep learning or neural learning system needs to be trained to generate inferences from input data. Details regarding inference and/or training logic 715 for a deep learning or neural learning system are provided below in conjunction with FIGS. 7A and/or 7B.

In at least one embodiment, inference and/or training logic 715 may include, without limitation, a data storage 701 to store forward and/or output weight and/or input/output data corresponding to neurons or layers of a neural network trained and/or used for inferencing in aspects of one or more embodiments. In at least one embodiment data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 701 may be included with other on-chip or off-chip data storage, including a processor's L1, L2, or L3 cache or system memory.

In at least one embodiment, any portion of data storage 701 may be internal or external to one or more processors or other hardware logic devices or circuits. In at least one embodiment, data storage 701 may be cache memory, dynamic randomly addressable memory (“DRAM”), static randomly addressable memory (“SRAM”), non-volatile memory (e.g., Flash memory), or other storage. In at least one embodiment, choice of whether data storage 701 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a data storage 705 to store backward and/or output weight and/or input/output data corresponding to neurons or layers of a neural network trained and/or used for inferencing in aspects of one or more embodiments. In at least one embodiment, data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 705 may be included with other on-chip or off-chip data storage, including a processor's L1, L2, or L3 cache or system memory. In at least one embodiment, any portion of data storage 705 may be internal or external to on one or more processors or other hardware logic devices or circuits. In at least one embodiment, data storage 705 may be cache memory, DRAM, SRAM, non-volatile memory (e.g., Flash memory), or other storage. In at least one embodiment, choice of whether data storage 705 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 701 and data storage 705 may be separate storage structures. In at least one embodiment, data storage 701 and data storage 705 may be same storage structure. In at least one embodiment, data storage 701 and data storage 705 may be partially same storage structure and partially separate storage structures. In at least one embodiment, any portion of data storage 701 and data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710 to perform logical and/or mathematical operations based, at least in part on, or indicated by, training and/or inference code, result of which may result in activations (e.g., output values from layers or neurons within a neural network) stored in an activation storage 720 that are functions of input/output and/or weight parameter data stored in data storage 701 and/or data storage 705. In at least one embodiment, activations stored in activation storage 720 are generated according to linear algebraic and or matrix-based mathematics performed by ALU(s) 710 in response to performing instructions or other code, wherein weight values stored in data storage 705 and/or data 701 are used as operands along with other values, such as bias values, gradient information, momentum values, or other parameters or hyperparameters, any or all of which may be stored in data storage 705 or data storage 701 or another storage on or off-chip. In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALUs 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 701, data storage 705, and activation storage 720 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., Flash memory), or other storage. In at least one embodiment, activation storage 720 may be completely or partially within or external to one or more processors or other logical circuits. In at least one embodiment, choice of whether activation storage 720 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 715 illustrated in FIG. 7A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, data storage 701 and data storage 705, which may be used to store weight values and/or other information, including bias values, gradient information, momentum values, and/or other parameter or hyperparameter information. In at least one embodiment illustrated in FIG. 7B, each of data storage 701 and data storage 705 is associated with a dedicated computational resource, such as computational hardware 702 and computational hardware 706, respectively. In at least one embodiment, each of computational hardware 706 comprises one or more ALUs that perform mathematical functions, such as linear algebraic functions, only on information stored in data storage 701 and data storage 705, respectively, result of which is stored in activation storage 720.

In at least one embodiment, each of data storage 701 and 705 and corresponding computational hardware 702 and 706, respectively, correspond to different layers of a neural network, such that resulting activation from one “storage/computational pair 701/702” of data storage 701 and computational hardware 702 is provided as an input to next “storage/computational pair 705/706” of data storage 705 and computational hardware 706, in order to mirror conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage computation pairs 701/702 and 705/706 may be included in inference and/or training logic 715.

### Neural Network Training and Deployment

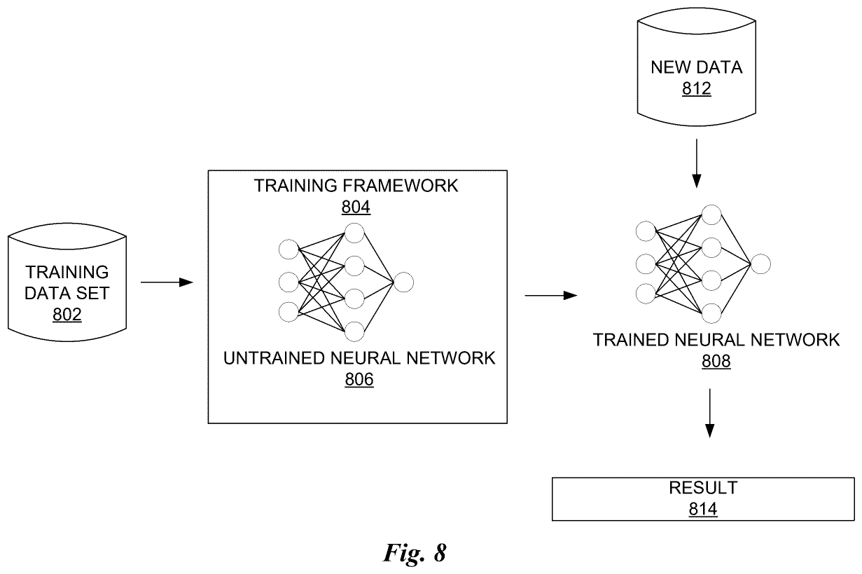

FIG. 8 illustrates another embodiment for training and deployment of a deep neural network. In at least one embodiment, untrained neural network 806 is trained using a training dataset 802. In at least one embodiment, training framework 804 is a PyTorch framework, whereas in other embodiments, training framework 804 is a Tensorflow, Boost, Caffe, Microsoft Cognitive Toolkit/CNTK, MXNet, Chainer, Keras, Deeplearning4j, or other training framework. In at least one embodiment training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having known output and the output of the neural network is manually graded. In at least one embodiment, untrained neural network 806 is trained in a supervised manner processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on known input data, such as new data 812. In at least one embodiment, training framework 804 trains untrained neural network 806 repeatedly while adjust weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, wherein untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map, which is a type of trained neural network 808 capable of performing operations useful in reducing dimensionality of new data 812. In at least one embodiment, unsupervised training can also be used to perform anomaly detection, which allows identification of data points in a new dataset 812 that deviate from normal patterns of new dataset 812.

In at least one embodiment, semi-supervised learning may be used, which is a technique in which in training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new data 812 without forgetting knowledge instilled within network during initial training.

### Data Center

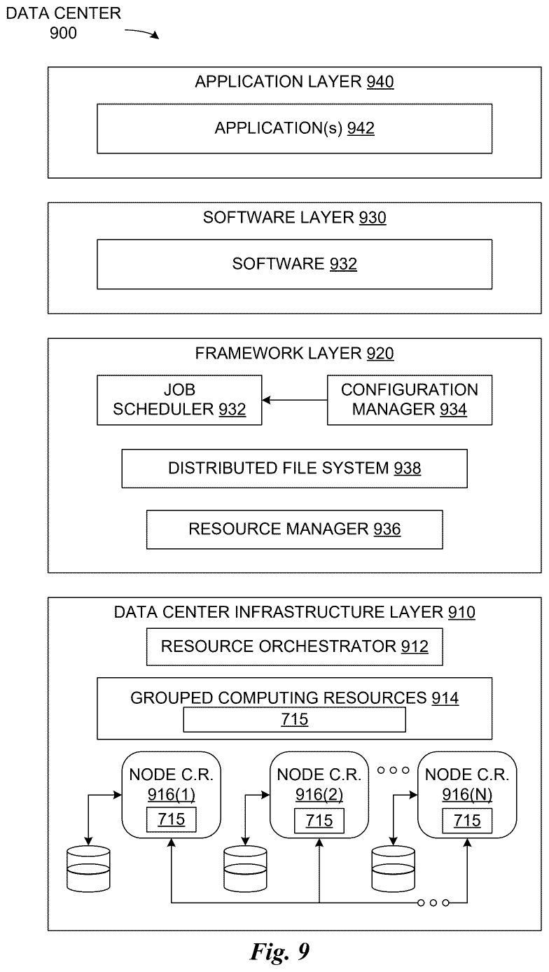

FIG. 9 illustrates an example data center 900, in which at least one embodiment may be used. In at least one embodiment, data center 900 includes a data center infrastructure layer 910, a framework layer 920, a software layer 930 and an application layer 940.

In at least one embodiment, as shown in FIG. 9, data center infrastructure layer 910 may include a resource orchestrator 912, grouped computing resources 914, and node computing resources (“node C.R.s”) 916(1)-916(N), where “N” represents any whole, positive integer. In at least one embodiment, node C.R.s 916(1)-916(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 916(1)-916(N) may be a server having one or more of above-mentioned computing resources.

In at least one embodiment, grouped computing resources 914 may include separate groupings of node C.R.s housed within one or more racks (not shown), or many racks housed in data centers at various geographical locations (also not shown). Separate groupings of node C.R.s within grouped computing resources 914 may include grouped compute, network, memory or storage resources that may be configured or allocated to support one or more workloads. In at least one embodiment, several node C.R.s including CPUs or processors may be grouped within one or more racks to provide compute resources to support one or more workloads. In at least one embodiment, one or more racks may also include any number of power modules, cooling modules, and network switches, in any combination.

In at least one embodiment, resource orchestrator 922 may configure or otherwise control one or more node C.R.s 916(1)-916(N) and/or grouped computing resources 914. In at least one embodiment, resource orchestrator 922 may include a software design infrastructure (“SDI”) management entity for data center 900. In at least one embodiment, resource orchestrator may include hardware, software or some combination thereof.

In at least one embodiment, as shown in FIG. 9, framework layer 920 includes a job scheduler 932, a configuration manager 934, a resource manager 936 and a distributed file system 938. In at least one embodiment, framework layer 920 may include a framework to support software 932 of software layer 930 and/or one or more application(s) 942 of application layer 940. In at least one embodiment, software 932 or application(s) 942 may respectively include web-based service software or applications, such as those provided by Amazon Web Services, Google Cloud and Microsoft Azure. In at least one embodiment, framework layer 920 may be, but is not limited to, a type of free and open-source software web application framework such as Apache Spark™ (hereinafter “Spark”) that may utilize distributed file system 938 for large-scale data processing (e.g., “big data”). In at least one embodiment, job scheduler 932 may include a Spark driver to facilitate scheduling of workloads supported by various layers of data center 900. In at least one embodiment, configuration manager 934 may be capable of configuring different layers such as software layer 930 and framework layer 920 including Spark and distributed file system 938 for supporting large-scale data processing. In at least one embodiment, resource manager 936 may be capable of managing clustered or grouped computing resources mapped to or allocated for support of distributed file system 938 and job scheduler 932. In at least one embodiment, clustered or grouped computing resources may include grouped computing resource 914 at data center infrastructure layer 910. In at least one embodiment, resource manager 936 may coordinate with resource orchestrator 912 to manage these mapped or allocated computing resources.

In at least one embodiment, software 932 included in software layer 930 may include software used by at least portions of node C.R.s 916(1)-916(N), grouped computing resources 914, and/or distributed file system 938 of framework layer 920. one or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 938 of framework layer 920. one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 934, resource manager 936, and resource orchestrator 912 may implement any number and type of self-modifying actions based on any amount and type of data acquired in any technically feasible fashion. In at least one embodiment, self-modifying actions may relieve a data center operator of data center 900 from making possibly bad configuration decisions and possibly avoiding underutilized and/or poor performing portions of a data center.

In at least one embodiment, data center 900 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 900. In at least one embodiment, trained machine learning models corresponding to one or more neural networks may be used to infer or predict information using resources described above with respect to data center 900 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 715 are used to perform inferencing and/or training operations associated with one or more embodiments. In at least one embodiment, inference and/or training logic 715 may be used in system FIG. 9 for inferencing or predicting operations based, at least in part, on weight parameters calculated using neural network training operations, neural network functions and/or architectures, or neural network use cases described herein.

As described herein, a method, computer readable medium, and system are disclosed to fine-tune a likelihood-based generative model. In accordance with FIGS. 1-6, embodiments may provide a likelihood-based generative model usable for performing inferencing operations and for providing inferenced data. The likelihood-based generative model may be stored (partially or wholly) in one or both of data storage 701 and 705 in inference and/or training logic 715 as depicted in FIGS. 7A and 7B. Training and deployment of the likelihood-based generative model may be performed as depicted in FIG. 8 and described herein. Distribution of the likelihood-based generative model may be performed using one or more servers in a data center 900 as depicted in FIG. 9 and described herein.

What is claimed is:

1. A method, comprising:
fine-tuning a target likelihood-based generative model by:
accessing a plurality of ground truth visual data samples and a plurality of reference visual data samples generated by a pretrained reference likelihood-based generative model,
processing the plurality of ground truth visual data samples and the plurality of visual reference data samples by a generative adversarial network (GAN) discriminator model parameterized using the target likelihood-based generative model, to generate classifications for the plurality of reference visual data samples and the plurality of ground truth visual data samples,
computing a GAN loss from the classifications, and
updating the target likelihood-based generative model to minimize the GAN loss; and
deploying the fine-tuned target likelihood-based generative model for:
processing an input comprised of noise to generate a visual content, and
outputting the visual content.

2. The method of claim 1, wherein the target likelihood-based generative model is initialized from the pretrained reference likelihood-based generative model.

3. The method of claim 1, wherein the target likelihood-based generative model is a diffusion model.

4. The method of claim 1, wherein the target likelihood-based generative model is an autoregressive model.

5. The method of claim 1, wherein each sample is classified by the GAN discriminator model as being either one of the plurality of reference data samples or one of the ground truth data samples.

6. The method of claim 1, wherein the pretrained reference likelihood-based generative model is frozen during the fine-tuning.

7. The method of claim 1, wherein the GAN discriminator model is implicitly parameterized using a likelihood ratio between the target likelihood-based generative model and the pretrained reference likelihood-based generative model.

8. The method of claim 1, wherein the fine-tuned target likelihood-based generative model is deployed to an execution environment.

9. The method of claim 8, wherein the fine-tuned target likelihood-based generative model is a generative model that processes the input to generate a new image.

10. A method, comprising:
at a device:
processing a plurality of ground truth data samples and a plurality of reference data samples generated by a pretrained reference likelihood-based generative model, by a generative adversarial network (GAN) discriminator model parameterized using a target likelihood-based generative model, to generate classifications for the plurality of reference data samples and the plurality of ground truth data samples; and
fine-tuning the target likelihood-based generative model based on a loss computed from the classifications.

11. The method of claim 10, wherein the target likelihood-based generative model is initialized from the pretrained reference likelihood-based generative model.

12. The method of claim 10, wherein the target likelihood-based generative model is a diffusion model.

13. The method of claim 10, wherein the target likelihood-based generative model is an autoregressive model.

14. The method of claim 10, wherein each sample is classified by the GAN discriminator model as being either one of the plurality of reference data samples or one of the ground truth data samples.

15. The method of claim 10, wherein the pretrained reference likelihood-based generative model is frozen during the fine-tuning.

16. The method of claim 10, wherein the GAN discriminator model is implicitly parameterized using a likelihood ratio between the target likelihood-based generative model and the pretrained reference likelihood-based generative model.

17. The method of claim 10, the method further comprising, at the device:
deploying the fine-tuned target likelihood-based generative model for performing one or more inferencing operations.

18. The method of claim 17, wherein the fine-tuned target likelihood-based generative model is a generative model that performs the one or more inferencing operations to generate new data.

19. The method of claim 17, wherein the fine-tuned target likelihood-based generative model is an autoregressive model that performs the one or more inferencing operations to predict a next data value in a sequence of data values.

20. A system, comprising:
a non-transitory memory comprising instructions; and
one or more processors in communication with the non-transitory memory, wherein the one or more processors execute the instructions to:
process a plurality of ground truth data samples and a plurality of reference data samples generated by a pretrained reference likelihood-based generative model, by a generative adversarial network (GAN) discriminator model parameterized using a target likelihood-based generative model, to generate classifications for the plurality of reference data samples and the plurality of ground truth data samples; and
fine-tune the target likelihood-based generative model based on a loss computed from the classifications.

21. The system of claim 20, wherein the pretrained reference likelihood-based generative model is frozen during the fine-tuning.

22. The system of claim 20, wherein the GAN discriminator model is implicitly parameterized using a likelihood ratio between the target likelihood-based generative model and the pretrained reference likelihood-based generative model.

23. A non-transitory computer-readable media storing computer instructions which when executed by one or more processors of a device cause the device to:
process a plurality of ground truth data samples and a plurality of reference data samples generated by a pretrained reference likelihood-based generative model, by a generative adversarial network (GAN) discriminator model parameterized using a target likelihood-based generative model, to generate classifications for the plurality of reference data samples and the plurality of ground truth data samples; and
fine-tune the target likelihood-based generative model based on a loss computed from the classification.

24. The non-transitory computer-readable media of claim 23, wherein the pretrained reference likelihood-based generative model is frozen during the fine-tuning.

25. The non-transitory computer-readable media of claim 23, wherein the GAN discriminator model is implicitly parameterized using a likelihood ratio between the target likelihood-based generative model and the pretrained reference likelihood-based generative model.
